(19) United States
(12) Patent Application Publication
(10) Pub. No.: US 2025/0161912 A1
(43) Pub. Date: May 22, 2025

(54) APPARATUS FOR PRODUCING SPHERICALLY GRANULATED SORBENT WITH A POLYMERIC BINDER

(71) Applicants: PAVEL KUDRYAVTSEV, Rehovot (IL); Nikolai Kudriavtsev, Haifa (IL); Elena Eisurovich, Hadera (IL)

(72) Inventors: PAVEL KUDRYAVTSEV, Rehovot (IL); Nikolai Kudriavtsev, Haifa (IL); Elena Eisurovich, Hadera (IL)

(21) Appl. No.: 18/517,937

(22) Filed: Nov. 22, 2023

(51) Int. Cl. B01J 20/28; B01J 20/30

(52) U.S. Cl. CPC B01J 20/28019; B01J 20/28028; B01J 20/3028; B01J 20/3042

(57) ABSTRACT

Proposed is an apparatus for continuous wasteless production of a spherically granulated sorbent with a polymeric binder. The apparatus contains a first reactor for preparing a polymer solution in a water-miscible organic solvent and a second reactor that receives the polymer solution from the first reactor and is loaded with a ground inorganic sorbent together with solid, wetting, dispersing additives and a surfactant, whereby a suspension is formed. The suspension is dispersed into a bath filled with water, where drops of the suspension transform into spherical granules of a composite sorbent, the polymer solidifies, and the granules are sent to a water-filled tank to soak the granules and extract the remaining solvent, whereby a spherically granulated sorbent is obtained. The granules are then dried and unloaded into a receiving container. The apparatus is equipped with a system to recover byproducts and return them to the production process.

### FIELD OF THE INVENTION

The present invention relates to the field of the chemical industry, in particular, to the area of extraction of lithium from lithium-containing natural and industrial solutions, more specifically, to an apparatus for continuous wasteless production of a spherically granulated sorbent with a polymeric binder for use in lithium extraction processes.

### DESCRIPTION OF THE PRIOR ART

Granulation is a process widely used in the industry for imparting materials shapes and properties convenient for dosing, treatment, handling, and transportation. Therefore, granulation is commonly used in medicine, agriculture, and the chemical industry.

One specific application of granulated materials is the use of granulated lithium-selective ion-exchangers, also known as lithium-selective sorbents, which are used to extract lithium from lithium-containing natural and industrial brines.

Known methods are based on mixing a powdered, inorganic compound with a polymer melt or solution and are used to manufacture products from plastics with inorganic compounds as fillers. After molding, the products are cured. These methods are initially aimed at obtaining non-porous materials and are of little use for obtaining ion-exchange materials.

Any powdered materials or their mixed compositions and pastes can be granulated in certain ways with appropriate equipment. Depending on the structure, properties of the granulated materials, requirements for the granulated product, as well as technical and economic considerations, various granulation methods are used. First, these include various methods of pressing, pelletizing, and molding.

Considering the need to obtain porous and durable sorbent granules, we will exclude from consideration pressing methods. Although these methods provide high strength and density, they minimize porosity, and this is unacceptable for inorganic sorbents, especially sorbents selective for lithium ions.

Pelletizing and forming technologies, as a rule, have the same organizational structure, consisting of three stages of the process: preparation of a granulated material, material shaping and convective processing.

At the preparation stage, homogenization and the required degree of mobility of the processed mass are ensured. Homogenization is necessary for all granulation methods, and the required degree of mobility of the granulated substance depends on the selected granulation method.

The classification of granulation methods is based on the peculiarities of the organization of the shaping process. This approach allows existing granulation methods to be combined into two main classes: pelletizing granulation and mold granulation.

Pelletizing combines a group of processes for which a characteristic feature is the movement of particles and individual aggregates of the granulated mass relative to each other and the walls of the apparatus. All pelletizing methods require the use of a liquid binder in the amount necessary to form granules in one of the granulating devices. The pelletizing process is most often carried out either in drum or disc granulators [O. V. Mamonov, V. N. Pashchenko, Granulation of inorganic sorbents, In collection. Chemistry and Technology of Inorganic Sorbents, Perm, 1979, p. 19-23]. Devices of both types are quite simple and reliable in operation, which is the reason for their widespread use in industry. However, these methods do not allow one to control the emerging pore structure of the resulting materials, which greatly limits the possibility of using such materials and devices for granulating inorganic sorbents selective for lithium ions, due to a significant deterioration in the kinetic properties of materials obtained by the aforementioned methods.

The main feature of the subsequent stages-shaping and subsequent processing—is their interdependence. For example, the significant polydispersity of the composition of the intermediate product excludes the possibility of using devices such as dynamic ion exchange columns with a moving and fluidized bed of sorbent, which are highly stable when operating only on granules with a narrow fractional composition.

The main difference between granulators based on the pelletizing method is the ability to classify the wet intermediate product on a plate. Granules produced in drum granulators are characterized by high heterogeneity of the fractional composition, which causes significant recycling loads. The amount of the material returned to the system for reprocessing can reach 100-400% of the finished product. All this increases metal consumption and reduces the intensity of equipment operation. The disadvantages of existing designs of disc granulators include high sensitivity to changes in the content of a liquid binder in the composition of the granulated mass and small limits for regulating the properties of granules. The granules obtained in such an apparatus are distinguished by greater density, which is associated with the significant magnitude of the centrifugal forces developed on the plate.

The second group of granulation processes is molding. These methods, in turn, can be divided into two types: compression molding and surface force molding. The compression molding method is extrusion. It consists in the forceful effect of the working members on the processed mass, which, being deformed, moves relative to the working surfaces, and acquires the required shape and size. Taking into account the design features of granulators of this class, both extrusion and molding granulators can be used for granulating sorbents. These granulators are divided into screw and rotary types [O. V. Mamonov, V. N. Pashchenko, Granulation of Inorganic Sorbents, In collection. Chemistry and Technology of Inorganic Srbents, Perm, 1979, p. 19-23].

A feature of extrusion granulators is a high specific molding pressure combined with intense mechanical impact on the material. This feature simultaneously determines both the advantages and disadvantages of this device. The advantages include a high degree of homogeneity and strength of the resulting granules, while the disadvantages include low porosity, energy intensity, and the possibility of thermal decomposition of the material due to heating during processing. Unlike extruders, molding granulators, due to surface forces, make it possible to obtain more porous granules, which is due to relatively low molding pressures—from 0 to 5 kg/cm².

As a rule, the above methods for manufacturing composite materials create compositions where the proportion of the polymer binder is predominant. At the same time, from a theoretical analysis of the problem of osmotic stability of inorganic ion-exchange materials, it follows that the hydrophobicity of polymer binders should contribute to an increase in the number of contacts between the active component and the binder and in the proportion of the active element on the pore surface. For this reason, a significant effect of strengthening the granules can be expected by introducing relatively small additives to the binder.

It is advantageous to impart to the granules a spherical shape. Advantages of spheroidization are the following: optimum flow and handling characteristics; a minimum surface area/volume ratio; optimum shape for coating and controlled release; easy mixing of non-compatible products; smooth spheres are an ideal base for applying a coating; minimum coating time and coating material used; elimination of dust, etc.

U.S. Pat. No. 5,011,640 issued to A. Zanchetta on Apr. 30, 1991 discloses a process and device for spherization of a powder material. One or more powders are placed in a leak-tight vessel having a substantially vertical axis and comprising a bottom blade rotating about an axis parallel to the axis of the vessel, and a spherization tool having a substantially discoidal rotating form. The powders are mutually mixed by means of the rotation of the bottom blade, and a binder solution is added thereto. The composition of mixed powders is spheronized by immersing the spherization tool in the composition and causing it to rotate simultaneously with the blade.

Russian Patent No. RU92001228A issued on Oct. 9, 1995 to V. Lozinsky, et al. discloses an apparatus for obtaining spherical pellets from water system-based material. The apparatus is provided with a freezing unit for maintaining temperature of a cooling liquid, a replaceable pellet collector mounted on the bottom of a pelletizing vessel and an additional vessel connected with the pelletizing vessel through a hydrophobic liquid supply closed circuit. The additional vessel has a nozzle mounted in the vessel bottom and oriented in the direction of feeding of drops. Capillary is dipped into liquid in the additional vessel. The apparatus provides the increased efficiency and enhance reliability in operation.

U.S. Pat. No. 3,890,072 issued on Jun. 17, 1975 to R. Barks discloses a method and apparatus of forming solid substantially spherical pellets from droplets of a slurry of finely divided solid aluminous particles and a deflocculant, delivered by gravity to and along a heated sloping surface at a temperature and of a length sufficient to dry the droplets of slurry en route therealong, and thereafter firing the slurry at the temperature and for the time necessary to fully develop high compressive strength and high temperature resistance therein. The apparatus contains a supporting unit having a continuous smoothly contoured upper surface extending between a relatively higher upper end and a relatively depressed lower end thereof exposed along its entire length to the ambient pressure of a normal atmospheric environment, and a unit for depositing droplets of the slurry upon the upper surface of the supporting unit and a drying device disposed adjacent to the supporting unit and operative upon the droplets adjacent to the upper end of the supporting unit so as to convert the droplets to dry relatively hard pellets by the time they slide down the upper surface of the supporting unit to its lower end.

U.S. Pat. No. 3,384,451 issued to C. Voiz on May 21, 1961 discloses a method for producing solid particles of a member selected from the group consisting of calcium and magnesium phosphate salts having susbtantially spherical configurations and generally insoluble or only slightly soluble in water. The method consists of heating a water slurry of a member of the aforementioned group of phosphate salts having a high degree of water content to dehydration temperature, agitating the slurry at dehydration temperatures to lower the water content of said salts and to form therefrom solid particles having substantially spherical configurations and separating the dehydrated particles from the slurry.

Russian Patent RU2444404C1 issued on Dec. 27, 2011, to N. F. Gladyshev et al. discloses a method for producing an agglomerated zeolite sorbent in spherical granules. The method includes preparing a suspension of powdered zeolite with a binder, dispersing the suspension into a liquid, separating the granules from the liquid, and heat treating them. In this case, polymers of fluorine derivatives of ethylene are used as a binder, a solvent selected from several ketones is used as a suspending agent, and water is used as a liquid. The technical result achieved in this case is to increase the sorption capacity and sorption kinetics of the resulting agglomerated zeolite, as well as to simplify the technological process for its production, in particular, to reduce the production cycle time when obtaining a unit of final product by 1.2 times.

However, the above method is disadvantageous in using solvents that have very low boiling points (acetone-t_{b}=56.1° C., t_{fl}=−20° C., methylethylketone-t_{b}=76.6° C., t_{fl}=16° C.), which leads to a high fire and explosion hazard in production. Methyl ethyl ketone also forms an azeotropic mixture with water (11 wt. % H2O, tb=73.45° C.), making solvent regeneration difficult. In addition, all ketones are highly toxic products. Moreover, the method calls for dispersing a suspension in a liquid. Direct dispersion of one liquid in another immiscible liquid leads to the formation of drops of the first in the mass of the second. However, such dispersion leads to the formation of fairly small emulsion droplets. In addition, these emulsion droplets usually have a wide variation in size, which leads to the production of granules with a wide size distribution, thus making it difficult to use them in technological processes.

The method also provides for heat treatment of the finished sorbent. Most likely, it is conducted for sintering polymers based on ethylene fluorine derivatives. All this increases the production cost.

It should be noted that the existing granulation plants and methods are mainly used for granulating fertilizers or pharmaceuticals. Moreover, for the latter, encapsulation methods are mainly used. These methods do not provide the set of properties needed for lithium-selective sorbent.

### SUMMARY OF THE INVENTION

The invention relates to an apparatus for continuous wasteless production of a spherically granulated sorbent with a polymeric binder, in particular, for producing a sorbent, which is also known as an ion-exchanger, suitable for extraction of lithium from lithium-containing natural or industrial brines. The assortment of polymers as binders may vary in a wide range.

The apparatus of the invention is intended for continuous wasteless production of a spherically granulated sorbent with a polymeric binder. The apparatus contains a first reactor for preparing a polymer solution in a water-miscible organic solvent. The first reactor is connected to a second reactor that receives the polymer solution from the first reactor and is loaded with a ground inorganic sorbent, solid additives, a dispersing additive and a surfactant, whereby a suspension is formed. The suspension is dispersed into a bath filled with water, where drops of the suspension transform into spherical granules of a composite sorbent. The polymer solidifies, and the granules are sent to a water-filled tank for soaking the granules and extraction of the remaining solvent. The granules are then dried and unloaded into a receiving container.

An essential part of the apparatus is a solvent regeneration system that recovers the byproducts and turns the apparatus into an installation of wasteless production. The regeneration system consists of a rectification column packed with a structured rectification packing, a first heat-exchanger, a second heat-exchanger, a third heat-exchanger, and a dephlegmator.

The solvent-water solution enters the rectification column through a first and second heat exchanger into the middle part of the rectification column, which is filled with a Sulzer-type packing. The water vapor generated in the column is lighter than the solvent vapor and rises to the top of the rectification column. From the top of the column, water vapor enters the third heat exchanger for condensation. After condensation and cooling in the third heat exchanger, the water condensate enters a dephlegmator, where it is divided into two streams. One condensate stream is used to reflux the rectification column, and the other stream, after cooling in the first heat exchanger, is returned to the water bath.

A high-boiling fraction consisting of a pure solvent is collected at the lower part of the column, where it is heated with a fourth heat exchanger to a temperature above the boiling point of water but lower than the solvent's boiling point. After cooling in the second heat exchanger, a part of the solvent is fed from the lower part of the column to a storage tank and then returned to the first reactor for reuse in preparing the polymer solution.

### BRIEF DESCRIPTION OF THE DRAWINGS

FIG. 1 is a schematic view of the apparatus of the invention for producing a spherically granulated sorbent with a polymeric binder.

FIGS. 2A, 2B, 2C, 2D, 2E, and 2F are schematic presentations of suspension dispersion device DD1, DD2, DD3, DD4, DD5, and DD6, respectively, suitable for use with the apparatus AP of the invention.

FIG. 3 is a vertical sectional view of another modification of a disk-type centrifugal spray mechanism for use in the apparatus of the invention for dispersing a suspension into a water bath.

FIG. 4 is a vertical sectional view of a pneumatic suspension spray nozzle device for use in the apparatus of the invention.

FIG. 5 shows a pneumatic suspension spray nozzle device that has an air atomizing part attached to a housing of a conventional centrifugal atomizer.

FIG. 6 is a schematic view of an encapsulator utilizing a nozzle-type suspension dispersion device.

FIG. 7 is a sectional view of a chamber-type dryer suitable for use with the apparatus of the invention.

FIG. 8 illustrates a rotary-type vacuum dryer equipped with a conical working container.

FIG. 9 is a schematic view of a multi-sectional dryer with a fluidized bed suitable for use with the apparatus of the invention.

### DETAILED DESCRIPTION OF THE INVENTION

### Description of a Preferred Embodiment

The present invention relates to the chemical industry field, particularly lithium extraction from lithium-containing natural and industrial solutions, to an apparatus for producing a spherically granulated sorbent with a polymeric binder for use in lithium extraction processes.

Before describing the apparatus for producing spherically granulated sorbent with a polymeric binder (hereinafter referred to as an “apparatus of the invention” or simply as “an apparatus”) and the operation of the apparatus, one should familiarize oneself with a process or method for manufacturing composite inorganic sorbents using polymeric binders for which this apparatus is intended.

The aforementioned method consists of the following stages: preparing a polymer solution in a water-miscible solvent and introducing a powder of an inorganic sorbent into the resulting solution to form a suspension of the inorganic sorbent in this polymer solution. The formulation includes various additives to improve the final product's technological process and properties of the final product. The obtained suspension is dispersed in one way or another in the air to form drops of the required size. The drops thus obtained fall under the influence of gravity into a bath of water, where each drop takes the shape of a sphere due to surface tension forces. The solvent is extracted into the water phase, which leads to the curing of the polymer and forms spherical particles of a composite structure, which constitute spherical granules of the composite sorbent.

This material preparation method makes it possible to vary the ratio of the composition components over a wide range and produce porous spherical granulates. In this case, the ratio of components is strictly limited and depends on the composition of the formulation and methods of manufacturing the granulate.

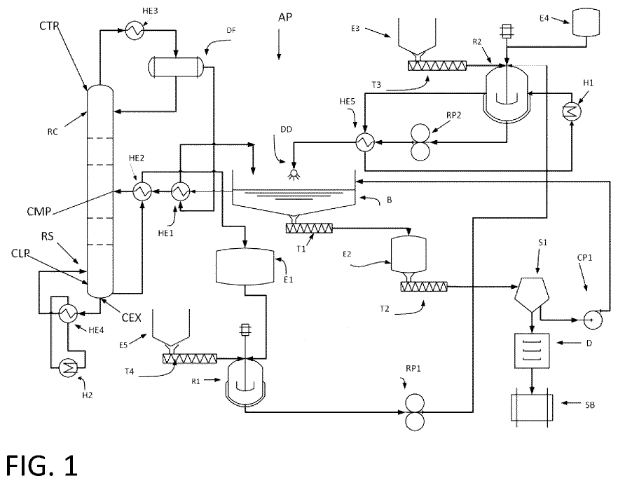

Referring now to the apparatus of the invention, let us consider FIG. 1, which is a general schematic view of the apparatus. In FIG. 1, the apparatus is designated by the symbol AP.

As seen from FIG. 1, the apparatus AP contains a first reactor R1, wherein a polymer solution in an organic water-miscible solvent is prepared. This reactor also serves as a supply container for supplying the prepared polymer solution to a second reactor R2, which is used for preparing a suspension of the sorbent in the polymer solution and in which the polymer is intended to be used as a polymeric binder in the composite spherical granules.

Examples of water-miscible solvents suitable for dissolving polymers in accordance with the present invention are the following: dimethyl acetamide, dimethyl formamide, dimethyl sulfoxide, and methylpyrrolidone. Their properties are shown in Table 1.

The reactor R1 is loaded with a solvent and a corresponding polymer in the form of powder or granules. This reactor is provided with a mixing device. The drive motor of the mixing device is turned on and initiates a mixing process. Mixing is continued until the resulting solution becomes homogeneous. The reactor R1 is made of stainless steel or ferrous metal with a ceramic or glass coating. For mixing, it is recommended to use anchor-type low-speed mixers made of the same material as the reactor itself. The reactor R1 is connected to a source of powder or granules of the corresponding polymer, a container E5, through a feed screw T4. The reactor R1 is connected to a reactor R2 through a transfer pump RP1.

Of the presented solvents, only N,N-Dimethylformamide is a flammable liquid and forms an azeotropic mixture with water.

This pump is intended for pumping the solution of the polymer that is contained in the first reactor.

The reactor R2 is made of the same material as the reactor R1. To effectively prepare a sorbent suspension in a polymer solution in reactor R1, a high-speed propeller or knife-type. Made of stainless steel is used.

The second reactor R2 is connected with a source of a finely grounded inorganic sorbent. e.g., a container E3, and a source of a surfactant, liquid wetting, and dispersing additives, i.e., a container E4. The finely ground sorbent with solid additives supplied to the second reactor R2 from the container E3, is needed to form a suspension, and the surfactant is used to stabilize the suspension.

TABLE 1
Properties of solvents recommended for preparing
polymer solutions in accordance with the invention.

| | Chemical | Boiling | Flash | | Azeotropic |
|---|---|---|---|---|---|
| Name | formula | point | point | Flammability | mixtures |
| N,N- Dimethylformamide | 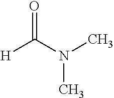 | 153° C. | 57.5 °C | Flammable liquids (Category 3) | toluene, n- heptane, water |
| Dimethyl sulfoxide | 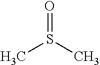 | 189° C. | 87° C. | No | methanol |
| N,N- Dimethylacetamide | 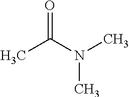 | 166° C. | 64° C. | No | acetic acid |
| Methylpyrrolidone | 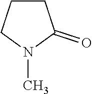 | 202° C. | 91° C. | No | ethylene glycol |

Examples of polymers suitable for dissolving in the aforementioned water-miscible solvents are shown in Table 2.

TABLE 2
Polymers used in the synthesis of spherically granulated sorbents

| Polymer | Chemical name | Short name |
|---|---|---|
| Veradel 3000P | Polyethersulfone, high Mw | PESU, |
| | | high Mw |
| Veradel 3600P | Polyethersulfone, low Mw | PESU, |
| | | low Mw |
| Luran 358N | Styrene Acrylonitrile | SAN |
| Kynar761 | Polyvinylidene fluoride homopolymer | PVDF |
| Inovyn 264 | Polyvinyl chloride homopolymer | PVC |
| Acryrex 207 | Polymethyl methacrylate | PMMA |
| BX-2 | Polyphenylene ether | PPE |
| KynarFlex 2801 | Hexafluoropropylene-Vinylidene- | HFPVF |
| | Fluoride copolymer | |

Formulations for the preparation of granulated sorbent are shown in Table 3.

TABLE 3
Formulations for the preparation of granulated sorbent

| Ingredient | | Formulation number and w/w % in the formulation | | | | | | | | | |
|---|---|---|---|---|---|---|---|---|---|---|---|
| Trade name | Chemical nature | 1 | 2 | 3 | 4 | 5 | 6 | 7 | 8 | 9 | 10 |
| Anti-terra U | Solution of a salt of | 0.7 | 1.2 | | 0.8 | 1.2 | 1.6 | 2.0 | 0.9 | 0.9 | 1.4 |
| | unsaturated polyamine | | | | | | | | | | |
| | amides and lower molecular | | | | | | | | | | |
| | weight acidic polyesters | | | | | | | | | | |
| Disperbyk 2200 | High molecular weight | | | 0.9 | | | | | | | |
| | copolymer with pigment | | | | | | | | | | |
| | affinity groups | | | | | | | | | | |
| N,N-Dimethylacetamide | N,N-Dimethylacetamide | 57.0 | 52.5 | 54.9 | 65.2 | 68.2 | 61.3 | 65.7 | 65.0 | | 57.7 |
| Dimethylformamide | Dimethylformamide | | | | | | | | | 64.4 | |
| Sorbent | Sorbent | 34.2 | 18.2 | 35.6 | 25.0 | 25.2 | 24.7 | 24.9 | 25.1 | 24.6 | 20.0 |
| Veradel PESU 3000P | Polyethersulfone, high Mw | | | | | | | | 9.1 | | |
| Veradel PESU 3600P | Polyethersulfone, low Mw | 8.1 | | 8.5 | | | | | | 10.1 | |
| INOVYN PVC 264PC | Polyvinyl chloride | | 6.3 | | | | | | | | 6.9 |
| | homopolymer | | | | | | | | | | |
| Luran ® 358N | Styrene Acrylonitrile | | | | 9.0 | | | | | | |
| Kynar761 | Polyvinylidene fluoride | | | | | 5.3 | | | | | |
| | homopolymer | | | | | | | | | | |
| KynarFlex 2801 | Hexafluoropropylene- | | | | | | | 7.4 | | | |
| | Vinylidene-Fluoride | | | | | | | | | | |
| | copolymer | | | | | | | | | | |
| ACRYREX CM-207 | Polymethyl methacrylate | | | | | | 12.4 | | | | |
| Tin(IV) oxide | Tin(IV) oxide | | | | | | | | | | 14.1 |
| Zirconium oxide | Zirconium oxide | | 21.9 | | | | | | | | |

An installation for grinding the sorbent is not shown in this drawing. Griding was conducted by a method and with the use of equipment similar to those disclosed in U.S. Pat. No. 5,855,326 issued to Beliavsky Y. on Jan. 5, 1999].

An important component of the apparatus AP is a granule-formation water bath B, filled with water and intended to form spherical granules of a composite sorbent and harden the polymer.

The granule-formation precipitation bath (hereinafter referred to as “water bath B>>) is a cylindrical tank with a conical bottom and a mixing device. The bottom slope should be within 10-15° to ensure the collection of the resulting granules in the central part of the apparatus and their subsequent movement into the system for completing solvent extraction and hardening of the granules. Intensive mixing of the water is conducted to prevent the drops of the suspension from sticking together in the bath. An external propeller-type stirrer (not shown) is used for mixing. An example of a water bath B suitable for the purposes of the invention is a Dora-type sedimentation tank. The tank can be made of sheet stainless steel or sheet PVC plastic. The precipitation bath has an overflow device to maintain a constant solution level.

An example of a granule-formation precipitation bath suitable for use in conjunction with the apparatus of the invention is a chemical settling reactor produced by Scientific-Production Company AKTIV, Sankt Peterburg, Russia. The settling reactor of this type has a low-speed anchor stirrer with a drive hole for introducing water and suspension drops. It is also equipped with a device for draining an excess solvent solution in water and removing sorbent granules through a pipe in the lower part of the settling reactor.

Alternatively, sedimental reactors produced by Enduramaxx. Ltd., Great Britain, can be used if equipped with a mixing device.

Settling-thickening tanks of this type are used to achieve separation of the liquid and solid fractions. Although these mechanisms have been developed for primary wastewater treatment, the same mechanisms can be used to separate solid sorbent granules from the aqueous liquid phase. When the settling tank operates, sorbent granules settle at the bottom of the tank under the influence of gravitational forces. The liquid supernatant is discharged through the outlet.

The spherical-granule-formation water bath B is equipped with a suspension dispersion device DD that is located above the bath B and is connected to the second reactor R2 via a second pump RP2 for conveying the suspension through the suspension dispersion device DD for dispersing the suspension into the water of the bath to form spherical granules of a composite sorbent and cause the polymer to harden.

The suspension dispersion device DD is the most challenging component of the granulation of a sorbent with a polymeric binder. The complexity of the execution of this device is to ensure satisfactory spray characteristics and acceptable dimensions of the deposition bath. The applicants have evaluated various dispersion devices of disc and nozzle types. The tests allowed the applicant to reveal the advantages and disadvantages of different suspension dispersion devices.

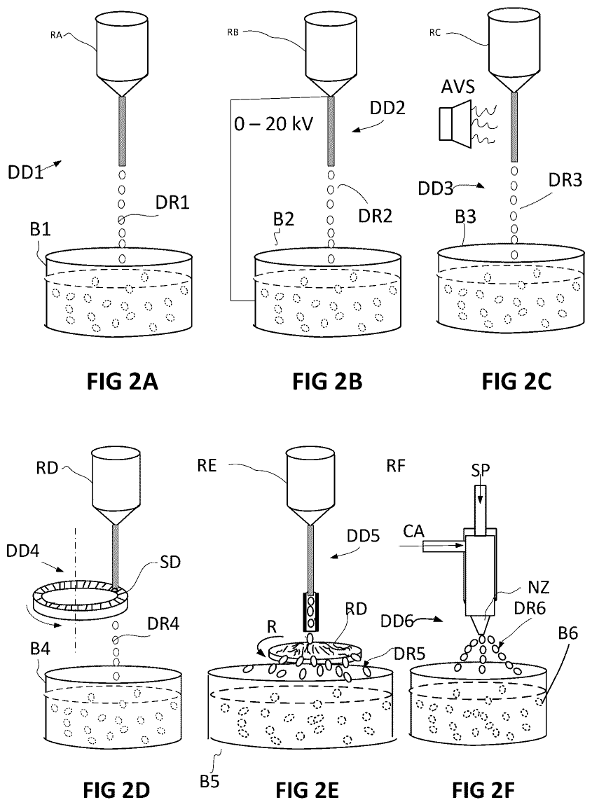

FIGS. 2A, 2B, 2C, 2D, 2E, and 2F are schematic presentations of suspension dispersion devices DD1, DD2, DD3, DD4, DD5, and DD6, respectively, suitable for use with the apparatus AP of the invention.

The device DD1 of FIG. 2A is the most straightforward dripping-type suspension dispersion device. The suspension drips from a container, e.g., a reactor RA, directly into a water bath B1.

The device DD2 of FIG. 2B is an electrostatic-type suspension dispersion device. This device is similar to one shown in FIG. 2A, except that an electrostatic charge with a potential of up to 20 kV acts on the continuous stream of a suspension at the exit from the reactor RB and thus stimulates breakage of the stream into separate droplets DR2. Reference numeral B2 designates the water bath.

The device DD3 of FIG. 2C is a vibration-type suspension dispersion device. This device is similar to one shown in FIG. 2B, except that the division of a continuous stream into droplets DR3 occurs under the effect of electro-acoustic oscillations generated by an acoustic vibration source AVS. DR3 designates droplets of the suspension, RC is a reactor, and B3 is a water bath.

In the string-cutter type suspension dispersion device DD4 of FIG. 2D, a continuous flow of the suspension that exists in a reactor is divided into droplets by a rotating disk PD with serrations SD on the periphery of the disk that interferes with the direction of the suspension that flows out from the reactor RD. B4 designates the water bath.

FIG. 2E illustrates a rotating-disk type suspension dispersion device DD5. In this device, a suspension falls onto the rotating disk. Under the effect of centrifugal forces, the liquid moves on the surface of the disk RD in a radially outward direction and flies out from the edges of the disk in the form of separate droplets. RE is a reactor, and B6 is a water bath.

FIG. 2F is a schematic view of a pneumatic nozzle-type suspension dispersion device DD6, wherein a jet of a liquid suspension is ejected from a nozzle NZ under the effect of compressed air fed into the device from a separate source. The reactor, from which the suspension is fed to the nozzle, is not shown, B6 designates a water bath.

Some of the suspension dispersion devices DD suitable for use in conjunction with the apparatus AP of the invention are described in more detail below.

In the technological process for sorbent production with the apparatus of the present invention, the inventors herein evaluated variants of a dispersion device DD (FIG. 1)

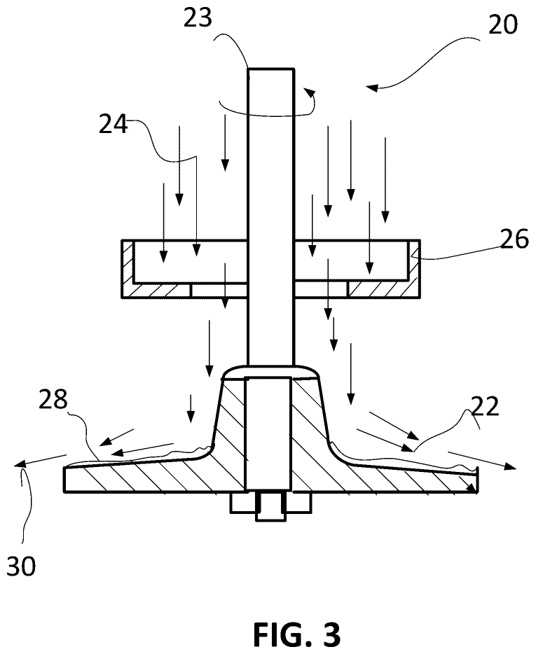

According to one aspect of the invention, a disk-type centrifugal spray mechanism 20, shown schematically in FIG. 3, may be used. The mechanism consists of a rotating disk 22, onto which a liquid suspension 24 is fed by the pump RP2 (FIG. 1) from the second reactor R2 through a deflector 26. The disk 22 is secured on a vertical shaft 23, driven into rotation from a drive motor via a system of reducers (not shown). The suspension forms a liquid film 28 on the surface of the disk 22. During the rotation of disk 22, under the effect of centrifugal forces, the suspension flows to the edges of the disk 22, departs from the edges, becomes unstable, and breaks up into droplets 30. When the droplets get into the water of the bath B, they form granules. The size of the granules is controlled by the speed of rotation of the disk 22 and the amount of supplied suspension 24.

The dispersion device DD in the form of the mechanism 20 is simple in construction but insufficiently effective in operation.

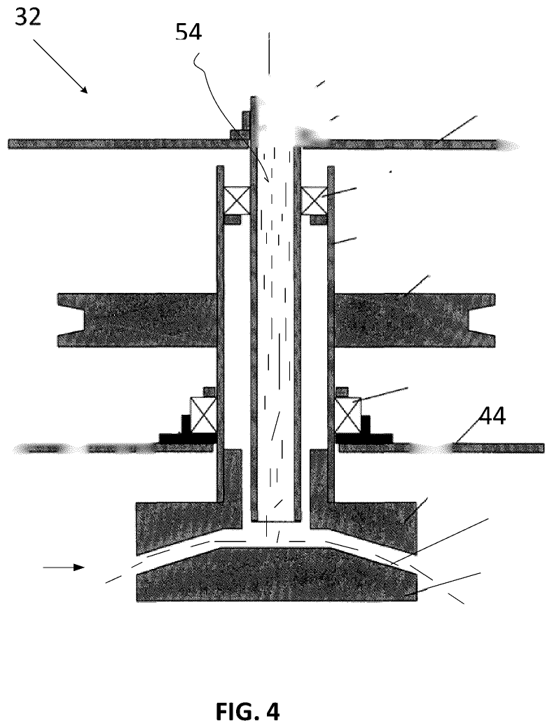

Later, a more efficient dispersion device DD, was used in conjunction with the apparatus AP. (FIG. 1) of the invention was developed. This also was a disk-type centrifugal spray mechanism. The improvement consisted of providing better spray characteristics and more acceptable dimensions of the water bath B. It was necessary to use a disk with a diameter of about 70 mm and ensure uniform wetting of the disk with the suspension. A schematic diagram of the improved device DD is shown in FIG. 4.

In general, the disk-type dispersing mechanism shown in FIG. 4 is designated by reference numeral 32. The mechanism is provided with a pipe 34, which at its upper end is fixed to a stationary upper base 35 by a clamp 36. A sleeve 38 is rotatingly installed on the stationary pipe 34 by an upper bearing 40. The sleeve is driven into rotation via a pulley 42 of a belt transmission (not shown). The pulley is fixed to the sleeve. The lower end of the rotating sleeve 38 is additionally supported by a lower base 44 via a lower bearing 43.

A dispersing member 46 is attached to the rotating sleeve 38 and consists of an upper disk 48 and a lower disk 50, which are attached to each other for joint rotation (the attachment is not shown in the drawing). The disk 50 is spaced from the disk 48 with a gap 52. The diameters of the disks are 70 mm, and the gap between the upper and lower disks is adjustable within 8 to 12 mm.

In operation, the suspension 54 is supplied from the reactor R2 (FIG. 1) by the pump RP2 through the center of the pipe 34 to the center of the lower rotating disk 50 and is uniformly distributed over the disk surface, wherefrom it is spread in the form of droplets onto the surface of water contained in the water bath B (FIG. 1).

This design of the suspension sprayer 32, shown in FIG. 3, provides a more uniform distribution of the suspension over the bath surface than the mechanism of FIG. 3.

All parts of the dispersing mechanism 32 are made of steel, except for the dispersing disks 48 and 50, which are made of fluoroplastic. The choice of fluoroplastic as a material for the dispersing disk is explained by the fact that this material ensures minimal adhesion of the suspension to the disk surface and, as a result, the most stable operation. A commutator motor (not shown) is used as a drive, allowing the rotation speed of the dispersing disks to be adjusted.

The dispersion device of FIG. 4 provides a suspension capacity of 30-40 dm³/hour, corresponding to 45-60 dm³ of granulate.

A disadvantage of all disk-type dispersers is a complex kinematic design and relatively low productivity. Their use is limited by application only for dispersing products that do not have adhesion to the structure's metal.

The mechanisms most effective for use in conjunction with the apparatus AP of the invention (FIG. 1) are suspension spray nozzles. Jet, centrifugal, pneumatic, and ultrasonic nozzles are distinguished by design.

Jet nozzles are the most straightforward design and represent a cylindrical tube from which a liquid stream flows under pressure, breaking into droplets.

In centrifugal nozzles, liquid moving under pressure swirls in a swirler with tangentially located channels. As a result, intense rotational movement is created in the chamber. The swirling flow enters the nozzle at its exit, breaking it into droplets. To form such a torch, liquid is supplied to the nozzle under pressure from 300 to 1000 kPa. The swirling flow nozzles are used to spray homogeneous low-viscosity liquids.

In ultrasonic nozzles, the liquid stream flowing from the hole is crushed under the influence of ultrasonic air vibrations created by a generator or under the action of rapid vertical movements of the plate occurring at an ultrasonic frequency.

Pneumatic nozzles are characterized by crushing the liquid with a jet of air or gas supplied under pressure. These nozzles can be divided into two groups-low and high pressure. The first group includes nozzles with excess pressure of the atomizing agent up to 10 kPa, and the second—from 100 to 1000 kPa or more.

Depending on the air supply methods, single-stage, two-stage, and multi-stage nozzles are distinguished. Based on the relative movement of liquid and air flows, nozzles are divided into a vortex or turbulent, counter-flow, and associated flow. In turbulent nozzles, the vortex movement of air and liquid is created using screw guides, tangential supply, etc.

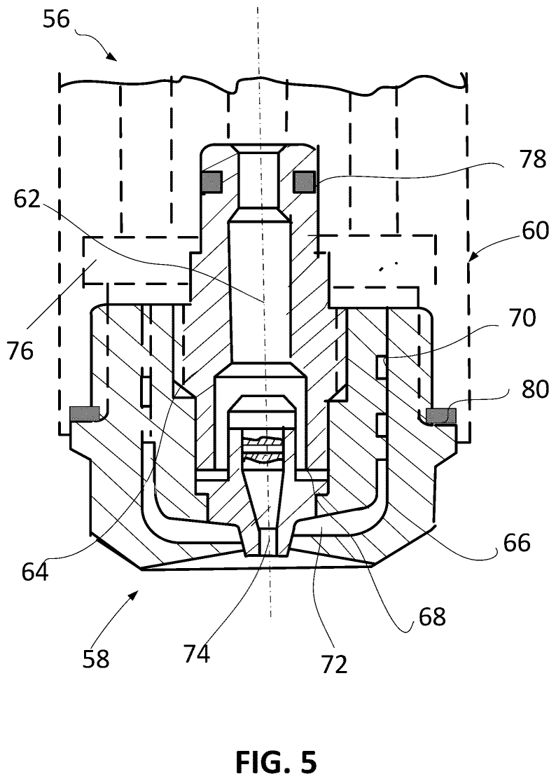

FIG. 5 shows a pneumatic suspension spray nozzle device 56 that has an air atomizing part 58 attached to a housing 60 of a conventional centrifugal atomizer (shown in FIG. 5 by broken lines). The nozzle device provides good spray fineness at low compressed air pressures. The nozzle device 56 has a central channel 62 that passes through the housing 60 of the conventional atomizer 60 and a central insert 64 of the housing 66 of the atomizing part 58. Reference numeral 68 designates one of the tangential channels formed in the central insert 64 laterally from the central channel 62, reference numeral 70 designates a ring channel, and 72 is a vortex chamber. The central insert is ended with a nozzle port 74. Reference numeral 76 designates an annual channel provided in housing 60 of the conventional centrifugal atomizer.

The liquid suspension is supplied from the reactor R2 (FIG. 1) by the pump RP2 to the central channel 62, then through two tangential channels 68, enters the vortex chamber 72, and leaves through the nozzle port 74. The air is fed through the annular channel 76 and passes through the housing 60 of the conventional atomizer 60 into the vortex chamber 72, where it twists and exits through the nozzle port 74. The liquid supply stage into the nozzle device is sealed with a rubber ring 78, and the air supply stage is sealed with a washer 80.

The pneumatic suspension spray nozzle devices shown in FIG. 5 have a more straightforward design than ultrasonic ones; they do not require liquid supply under pressure from 300 to 1000 kPa, like centrifugal ones. The use of a jet nozzle is problematic due to the viscosity of the dispersed solution. Using a pneumatic nozzle device such as the device 56 to disperse a suspension of a polymer and sorbent is especially advisable since the solution contains solid particles. The large bore sizes of the nozzle channels significantly reduce the likelihood of clogging, and the dispersion of viscous liquids with high adhesion requires atomization under air or gas pressure.

It is possible to improve atomization from a nozzle in several ways: by heating, increasing the supply pressure, or choosing the optimal nozzle design.

The first way, namely, heating the suspension before dispersing, is the most acceptable since it presents fewer difficulties; in addition, heating reduces the viscosity of the suspension so much that it allows the suspension to be sprayed with a lower solvent content. This, in turn, makes it possible to obtain granules with a larger bulk mass, higher strength, and faster hardening in the precipitation bath.

A heater H1 may be installed on the way of the suspension to the suspension dispersion device DD between the second reactor R2 and the fifth heat-exchanger HE5. A second heater H2 may be installed in parallel to the fourth heat-exchanger HE4 (see FIG. 1). When the temperature of the liquid increases, this increases the velocity of the flow.

Tubular heating elements from WATTCO Co. (USA, California) are suitable for use as heaters H1 and H2.

The possibility of using a pneumatic nozzle to spray a polymer suspension with a viscosity of 200-300 CGT was experimentally established. Dispersing a suspension with high viscosity is possible since, in the case of obtaining composite sorbents, there is no need for very fine spraying. The size of the suspension droplets determines the size of the resulting sorbent granules.

Examples of commercially available suspension dispersion devices most suitable for use in the apparatus of the invention are Encapsulator B-390 manufactured by BUCHI, a NISCO encapsulation unit manufactured by NISCO Engineering Inc., and Spherisator M2 manufactured by BRACE GmbH.

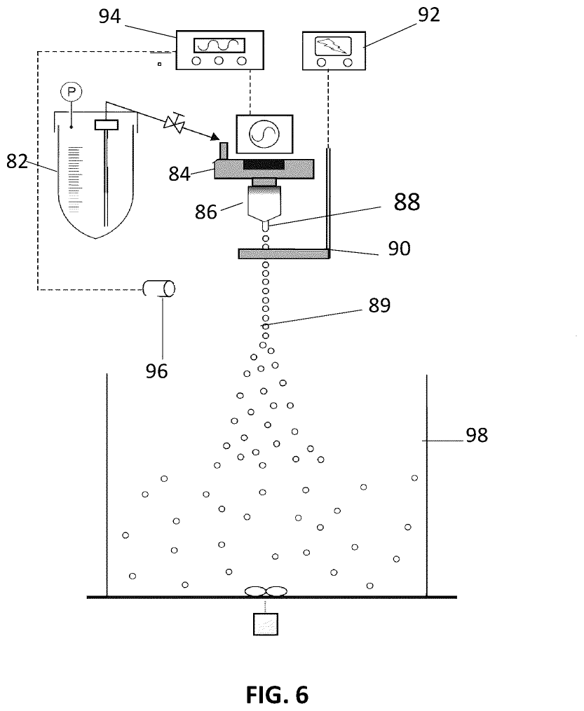

A schematic view of the Encapsulator B-390 of BÜCHI AG, Switzerland, is shown in FIG. 6. In the drawing, reference numeral 82 designates a pressure bottle, 84 is a bead producing unit, 86 is a vibration unit, 88 is a single nozzle, 89 is a stream of droplets, 90 is an electrode, 92 is a dispersion control unit, 94 is a vibration control unit, 96 is an LED stroboscope, and 98 designates a polymerization bath.

The product to be encapsulated is mixed with a binder polymer, and the obtained mixture is put into the pressure bottle 82. The polymer-product mixture is forced into the bead producing unit 84 by air pressure (P). The liquid then passes through a precisely drilled nozzle 88 and separates into equal size droplets 89 on exiting the nozzle. These droplets pass through an electrical field between the nozzle 88 and the electrode 90, resulting in a surface charge. Electrostatic repulsion forces disperse the beads as they drop into the hardening bath 98. The polymerization bath must be electrically grounded.

Optimal parameters for bead formation are indicated by visualization of real-time bead formation in the light of a stroboscope lamp 96. When optimal parameters are reached, a standing chain of droplets is clearly visible. Once established, the optimal parameters can be preset for maintaining them in the process.

At the conclusion of the production run, the hardening solution is drained off, and washing solutions, or other reaction solutions, are added to further process the beads if needed.

The spherical granules formed in the bath B are transported by a first transporting device T1, e.g., a conveying screw, to a first tank E2, which contains water and is linked to the exit of the granule formation bath B. The spherical granules are transported to this tank to soak in the water and extract the residual organic water-miscible solvent from the granules.

The apparatus AP is provided with a phase separator S1, which is used for separating a solid phase from a liquid phase contained in the first tank E2. The spherical granules are conveyed to the phase separator S1 by a second transporting device T2, which may also be, e.g., a conveying screw.

Transporting devices suitable for use in conjunction with the present invention may be exemplified by screw conveyors produced by Sodimate Co., Chicago, USA.

since, in the case of obtaining composite sorbents, there is no need for very fine spraying. The size of the suspension droplets determines the size of the resulting sorbent granules.

As mentioned above, from the water bath B the suspension is conveyed to the first tank E2 by the transporting device E2, such as a screw conveyor of the type mentioned earlier. Then, from the tank E2, the spherical granules are conveyed to the phase separator S1 by a second transporting device T2, which may also be, e.g., a conveying screw.

The most suitable devices for separating granules from water are separators with an inclined screen. Such separators are produced, for example, by Yipu Environmental Protection Group Co., China.

The main part of these inclined screen solid-liquid separators is a flat surface stainless-steel sieve made of wedge-shaped steel wires. The sorbent suspension in water to be processed is evenly distributed over the inclined surface of a stainless-steel sieve through an overflow. The suspension gap is large and smooth to prevent blocking. The sorbent granules are captured, and the filtered water flows out of the gap of the sieve plate and is discharged through the drainpipe (FIG. 1) to the third pump CP1 and then pumped by this pump back to the water bath B.

The phase separator S1 is connected to a granule dryer D used for drying the spherical granules with the polymer as the binder. In the dryer D, a liquid phase that may still be contained in the granules is further separated from the solid phase.

Batch and continuous systems can be used as dryers. Drying temperatures should not be raised above 0.6 of the melting point Tₘₑₗₜ of the polymer used. It is possible to use systems with additional activation of drying using microwave or ultrasound.

Dryers may be of different types. Driers suitable for use in conjunction with the apparatus of the invention are listed below.

Standard dryers suitable for incorporation into the apparatus of the invention are shown below.

Chamber-type dryers have significant disadvantages, which include: 1) long drying times since the layer of material being dried is stationary, 2) uneven drying, 3) heat loss when loading and unloading chambers, 4) complex and unhygienic conditions for maintenance and process control, 5) relatively high energy consumption due to insufficient utilization of the heat of the drying agent (especially in the final drying period).

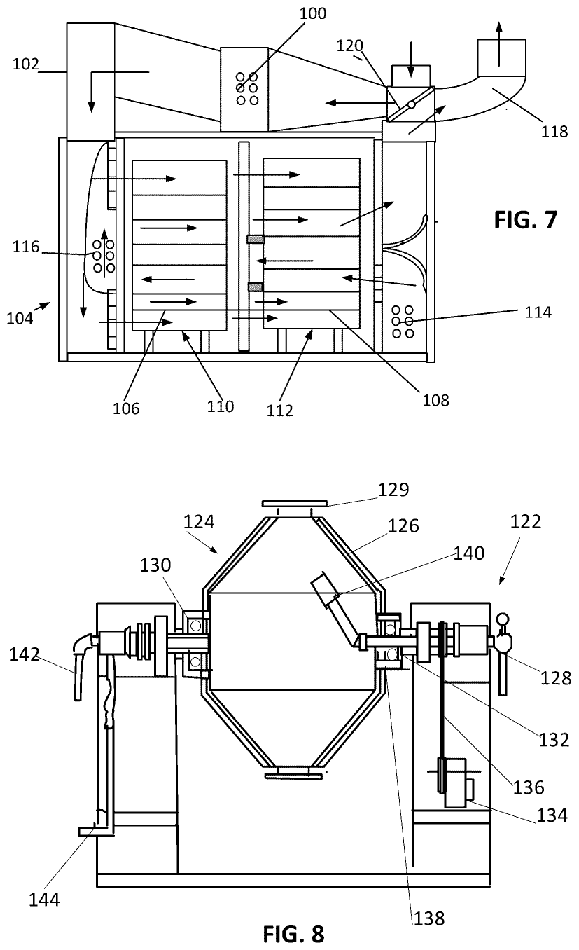

A type of chamber dryer is a cabinet air-circulation dryer, which operates with intermediate heating and recirculation of part of the air. An example of a chamber dryer is schematically shown in FIG. 7. This dryer is a so-called cabinet air-circulation dryer, which operates with intermediate heating and recirculation of part of the air. The air heated in the air heater 100 is supplied by a fan 102 to the lower part of the dryer chamber 104. It passes in the horizontal direction (from left to right) between the trays 106, and 108 with the material to be dried, installed on the trolleys 110 and 112, respectively. Then, the air passes into the air heater 114 and moves through the middle part of chamber 104 in the opposite direction (from right to left). For the third time, the air is heated in air heater 116, then passes to the right through the upper part of the chamber and is removed from the dryer through a pipe 118. Thus, the air in the dryer moves in a zigzag pattern through three zones, is heated twice, and changes the direction of its movement in the chamber twice. A part of the exhaust air is returned to the dryer to regulate its amount using a damper 120. The product that is subject to drying is moved into the chamber and out of the chamber on trolleys 110 and 112. The interior of the chamber is sealed with an openable door (not shown in the drawing).

FIG. 8 illustrates a rotary-type vacuum dryer 122. This device is equipped with a conical working container 124. Under vacuum conditions in the container, oil or hot water is supplied to the heat exchange jacket 126 to heat the original product. The evaporation resulting from heating is pumped out by a vacuum pump (not shown) through a hose 128 connected to a vacuum system. The container 124 slowly rotates in bearing units 130 and 132 from an electric motor 134 through a belt transmission 136 and a rotary coupling 138. Reference numeral 139 designates a loading/unloading port, 140 designates a filter. The heating medium is fed through an inlet pipe and is removed from the device through an outlet pipe 144.

The vacuum helps to increase the speed and efficiency of drying, which ensures that the product dries evenly.

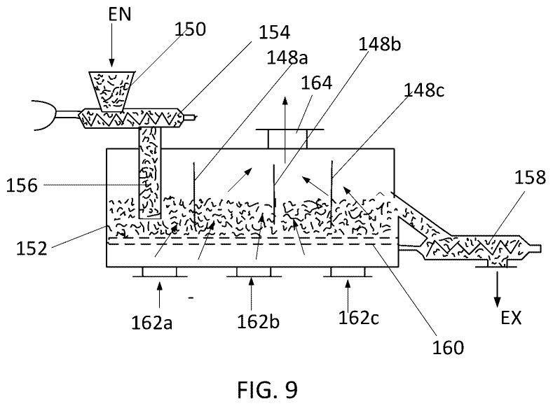

A separate group of dryers are fluidized-bed type dryers. One such dryer is shown schematically in FIG. 9. The illustrated dryer is a multi-chamber structure divided into sections by vertical partitions 148a, 148b, 148c. The material is loaded via a loading hopper 150 and is conveyed to a drying chamber 152 by a feed screw 154 via a loading tube 156. Reference numeral 158 designates an unloading feed screw.

The material is located above a support grid 160 in a state of fluidization created by the heating medium penetrating the material. The heating medium is supplied to each section beneath the grid 160 via medium entering ports 162a, 162b, 162c and exits via an outlet port 164. The material sequentially passes through all sections. Arrow EN designates the loading of the wet material, and arrow EX designates the unloading of the dried material. The material is maintained in a fluidized state by flows of the supplied heating medium. It is advisable to use such dryers when drying materials containing internal moisture when a long drying time is required. Arrows show the directions of the heating medium.

Tray dryers produced by Changzhou Bole Technical Co., Ltd (Changzhou City, China) are drying ovens of a common type for drying various materials, including spherically granulated sorbents obtained in the apparatus of the invention by the dryer D from the phase separator S1 in the form of a solid phase.

These ovens are characterized by a wide scope of application, uniformity of temperature, high efficiency of heating, and ease of operation. To save energy, a flow of circulating air conducts drying. Heat sources may differ, e.g., electricity, hot water, or far infrared radiation. Such an oven is used at the applicants' facility.

Another example of a drying equipment suitable for incorporation into the apparatus of the invention is a microwave drying equipment of Baixiv Machinery (Gongui, Henan, China). The dryers produced by the above company are suitable for microwave drying various chemical materials, including the products of the apparatus of the invention. The output of the microwave dryers can be selected in the range of 100 to 2000 kg/h, drying time may vary in the range of 30 min to 3 hours, heat source-electrical. Heating is fast and uniform.

The applicants have tested and received positive results by drying the granules in an ultrasonic dryer of Heat Technologies, Inc., Atlanta, USA. This company's Spectra HE™ Ultra acoustic drying technology imparts to the heating air flow ultrasonic oscillations that result in 3 to 5 times more efficient drying than with a steady-state air velocity airflow. Ultrasonic vibration provides excellent micro-mechanical excitation of the moisture molecules (water or solvent). Heat and mass transfer coefficients are higher, naturally allowing liquids to be removed at accelerated rates.

The dried composite spherical granules are discharged from the dryer D to a dried spherical granule collector SB for collecting the final spherically granulated sorbent with a polymeric binder (FIG. 1).

According to one aspect of the invention, the apparatus AP may be further provided with a regeneration system RS, which turns the apparatus into an installation of continuous action with wasteless production of the composite spherical sorbent. The regeneration system RS consists of a rectification column RC packed with a structured rectification packing, a first heat-exchanger HE1, a second heat-exchanger HE2, a third heat-exchanger HE3, and a dephlegmator DF. The rectification column RC has a top portion CTP, a lower part CLP, a midpoint CMP in the column intermediate part, and an exit CEX (FIG. 1).

The water bath B is connected to the midportion CMP of the rectification column RC via the first heat exchanger HE1 and the second heat exchanger HE2 for passing the solvent-water solution from the bath B to the regeneration system RS. The third heat exchanger HE3 is installed between the top portion CTP of the rectification column RC and the dephlegmator DF, the latter being connected through the first heat-exchanger HE1 to a bath irrigation pipe BIP located above the water bath B for pouring a portion of a condensate formed in the dephlegmator DF to the water bath B.

According to a further aspect of the invention, the apparatus AP contains a fourth heat exchanger HE4 located between the exit CEX of the rectification column RC and the lower part CLP of the column. The fourth heat exchanger is intended for heating a high-boiling fraction that consists of a solvent with water impurities accumulated at the lower part CLP of the RC rectification column above the boiling point of water but lower than the boiling point of the water-miscible solvent.

The lower part CLP of the rectification column RC is connected with the first reactor R1 through the second heat exchanger HE2 and a first storage tank E1 for feeding the water-miscible solvent to the first reactor R1, where it is reused for preparing the polymer solution (FIG. 1).

### Description of the Apparatus Operation

The apparatus of the invention AP operates as follows.

Before activation of the apparatus AP (FIG. 1), all the containers and tanks are filled with appropriate liquid and solid components. More specifically, the tank B is filled with water, the container E3 is filled with finely ground inorganic sorbent with solid additives, the container E4 is filled with a surface-active substance, liquid wetting and dispersing additives and the rectification column RC is packed with an appropriate structured rectification packing.

In the first reactor R1, a polymer solution is prepared by adding a polymer to a water-miscible solvent. The polymers suitable for use with the apparatus AP of the invention are listed in Table 3.

The pump RP1 pumps the resulting solution to the second reactor R2, where a powder of the finely ground inorganic sorbent with solid additives is introduced from the container E3 to form a suspension of the sorbent in the water-miscible solvent in the polymer solution. The surfactant is introduced from the container E4 to stabilize the suspension.

The resulting suspension is fed to the bath B using the pump RP2 and is dispersed into the bath by the suspension dispersion device DD. In this case, the organic solvent is replaced by water in the suspension drops, which causes the polymer to form and harden the granules. The solvent remaining in the granules is further extracted into the aqueous phase.

From the bath B, the granules are fed by the first transporting device T1, into the tank E2, where the granules are soaked in water, and additional extraction of the solvent occurs.

From the tank E2, the second transporting device T2 feeds the granules into the separator S1 to separate the solid and liquid phases. The liquid phase is poured back into bath B. The granules are fed to the dryer D for drying. After drying, the granules are packed into the dried spherical granule collector SB.

During the operation of the apparatus AP, the solvent accumulates in the bath B. As described above, the solvent solution in water is fed to the regeneration system RS that consists of the rectification column RC column, heat exchangers HE1, HE2, HE3, HE4, and the dephlegmator DF.

The solvent-water solution enters the rectification column RC through the heat exchangers HE1 and HE2. From the heat exchangers, the heated solution is fed through the midpoint CMP of the column into the intermediate part of the rectification column RC filled with a Sulzer-type packing.

As water vapor formed in the column RC is lighter than the solvent, it rises to the top portion CTP of the rectification column RC.

After cooling in the heat exchanger HE3, a water condensate is formed. It enters the dephlegmator DF, from where one part of the condensate flow is used to irrigate the rectification column, and the other part, after cooling in the heat exchanger HE1, returns to the bath B through the bath irrigation pipe.

A high-boiling fraction consisting of a pure solvent is collected at the lower part CLP of the column RC, where it is heated with the heat exchanger HE4 to a temperature above the boiling point of water but lower than the solvent's boiling point.

After cooling in the heat exchanger HE2, one part of the solvent is fed from the lower part CLP of the column RC to the storage tank E1 and from there to the reactor R1 to prepare the polymer solution.

As a result, spherical particles are obtained, which are granules of the composite sorbent.

This material preparation method makes it possible to vary the ratio of the composition components over a very wide range and ensures the production of porous spherical granulates.

Thus, the invention has been shown to provide an apparatus for continuous wasteless production of spherically granulated sorbent with a polymeric binder for use in lithium extraction processes. Although the invention was described and illustrated concerning specific examples, it should be understood that these examples should not be construed as limiting the scope of the practical application of the invention and that any changes and modifications are possible within the limits of the attached claims. For example, the drying systems described and shown above are given only as examples, and many other drying apparatuses may be suitable for the purposes of the invention, such as tunnel dryers, etc. The same relates to suspension dispersion devices that may be embodied differently from those shown in the drawings. Suspension conveying devices are not necessarily fed screws or pumps. Application of the apparatus of the invention is not limited to the manufacture of spherically granulated sorbent for use in lithium extraction processes but for the manufacture of spherical granules from materials other than sorbents.

1. An apparatus for producing spherically granulated sorbent with a polymeric binder comprising:
a first reactor filled with a solution of a polymer in an organic water-miscible solvent, the polymer being used as a polymeric binder;
a second reactor connected to the first reactor via a first pump for pumping the solution of the polymer in the organic water-miscible solvent from the first reactor to the second reactor;
a source of a powder of a finely ground inorganic sorbent with solid additives and a source of a surfactant, both connected to the second reactor, wherein the finely ground inorganic sorbent is used for preparing a suspension of the finely ground inorganic sorbent in the solution of the polymer in an organic water-miscible solvent, wetting and dispersing additives and the surfactant is used for stabilizing the suspension;
a spherical-granule-formation water bath filled with water and intended for receiving the suspension from the second reactor;
a suspension dispersion device located above the spherical-granule-formation water bath and connected to the second reactor via a second pump for pumping the suspension through the suspension dispersion device and for dispersing the suspension into the water of the spherical-granule-formation water bath to form spherical granules of a composite sorbent and cause the polymer formation and hardening;
a first tank, which contains water and is linked to the spherical-granule-formation water bath via a first transportation device for conveying the spherical granules to the first tank for soaking the spherical granules in the water and additionally extracting the organic water-miscible solvent;
a separator for separating a solid phase from a liquid phase contained in the spherical granules, the separator being linked to the first tank via a second transportation device for passing the spherical granules from the first tank to the separator;
a granule dryer connected to the separator for drying the spherical granules with the polymer as the binder; and
a dried spherical granule collector for collecting the spherically granulated sorbent with the polymeric binder.

2. The apparatus of claim 1, further comprising:
a third pump installed between the separator and the spherical-granule-formation water bath for pumping the liquid phase from the separator back to the spherical-granule-formation water bath.

3. The apparatus of claim 1, further comprising a regeneration system comprising a rectification column packed with a structured rectification packing and having an entrance, a top portion, a lower part, a midpoint, and an exit, a first-heat exchanger, a second heat-exchanger, a third heat-exchanger, and a dephlegmator, wherein the spherical-granule-formation water bath is connected to a midportion of the rectification column via the first heat-exchanger and a second heat-exchanger for passing the solvent-water solution to the regeneration system through the first heat-exchanger and the second heat-exchanger, the third heat exchanger being installed between the top portion of the rectification column and the dephlegmator, wherein the dephlegmator is connected through the first heat-exchanger to a bath irrigation pipe located above the spherical-granule-formation water bath for pouring a portion of a condensate formed in the dephlegmator to the spherical-granule-formation water bath.

4. The apparatus of claim 2, further comprising a regeneration system comprising an RC rectification column packed with a structured rectification packing and having a top portion, a lower part, a midpoint, and an exit, a first-heat exchanger, a second heat-exchanger, a third heat-exchanger, and a dephlegmator, wherein the spherical-granule-formation water bath B is connected to a midportion of the rectification column via the first heat-exchanger and a second heat-exchanger for passing the solvent-water solution to the regeneration system through the first heat-exchanger and the second heat-exchanger, the third heat exchanger being installed between the top portion of the rectification column and the dephlegmator, wherein the dephlegmator is connected through the first heat-exchanger to a bath irrigation pipe located above the spherical-granule-formation water bath for pouring a portion of a condensate formed in the dephlegmator to the spherical-granule-formation water bath.

5. The apparatus of claim 4, further comprising a fourth heat-exchanger located between the exit and the lower part of the rectification column and intended for heating a high-boiling fraction accumulated at the lower part of the rectification column above the boiling point of water, but lower than the boiling point of the water-miscible solvent.

6. The apparatus of claim 5, wherein the lower part of the rectification column is connected to the first reactor through the second heat exchanger and a second storage tank for feeding the water-miscible solvent to the first reactor, where it is reused for preparing the polymer solution.

7. The apparatus of claim 1, further provided with a first heater installed between the second reactor and the fifth heat-exchanger.

8. The apparatus of claim 7, further provided with a second heater installed in parallel to the fourth heat-exchanger

9. The apparatus of claim 1, wherein a suspension dispersion device is selected from the group consisting of a dripping-type suspension dispersion device, an electrostatic-type suspension dispersion device, a vibration-type suspension dispersion device, a string-cutter type suspension dispersion device, a rotating-disk type suspension dispersion device, and a pneumatic-nozzle type suspension dispersion device.

10. The apparatus of claim 6, wherein a suspension dispersion device is selected from the group consisting of a dripping-type suspension dispersion device, an electrostatic-type suspension dispersion device, a vibration-type suspension dispersion device, a string-cutter type suspension dispersion device, a rotating-disk type suspension dispersion device, and a pneumatic-nozzle type suspension dispersion device.

11. The apparatus of claim 8, wherein a suspension dispersion device is selected from the group consisting of a dripping-type suspension dispersion device, an electrostatic-type suspension dispersion device, a vibration-type suspension dispersion device, a string-cutter type suspension dispersion device, a rotating-disk type suspension dispersion device, and a pneumatic-nozzle type suspension dispersion device.

12. The apparatus of claim 1, wherein a dryer is selected from the group consisting of an air-circulation chamber-type dryer, a rotary-type vacuum dryer, and a fluidized-bed type dryer.

13. The apparatus of claim 8, wherein a dryer is selected from the group consisting of an air-circulation chamber-type dryer, a rotary-type vacuum dryer, and a fluidized-bed type dryer.

14. An apparatus for producing spherically granulated sorbent with a polymeric binder comprising:
a first reactor filled with a solution of a polymer in an organic water-miscible solvent, the polymer being used as a polymeric binder;
a second reactor connected to the first reactor for receiving the solution of the polymer in the organic water-miscible solvent from the first reactor;
a source of a powder of a finely ground inorganic sorbent with solid additives, wetting and dispersing additives, and a source of a surfactant, both connected to the second reactor, wherein the finely ground inorganic sorbent is used for preparing a suspension of the finely ground inorganic sorbent in the solution of the polymer in an organic water-miscible solvent, wetting an dispersing additives and the surfactant is used for stabilizing the suspension;
a spherical-granule-formation water bath filled with water;
a suspension dispersion device located above the spherical-granule-formation water bath and connected to the second reactor for receiving the suspension through the suspension dispersion device and for dispersing the suspension into the water of the spherical-granule-formation water bath to form spherical granules of a composite sorbent and cause the polymer to harden;
a first tank, which contains water and is linked to the spherical-granule-formation water bath for receiving the spherical granules, for soaking the spherical granules in the water, and additionally extracting the organic water-miscible solvent from the spherical granules;
a separator for separating a solid phase from a liquid phase contained in the spherical granules, the separator being linked to the first tank;
a granule dryer connected to the separator for drying the spherical granules; and
a dried spherical granule collector for collecting the spherically granulated sorbent with the polymeric binder.

15. The apparatus of claim 14, further comprising a regeneration system comprising a rectification column packed with a structured rectification packing and having a top portion, a lower part, a midpoint, and an exit, a first-heat exchanger, a second heat-exchanger, a third heat-exchanger, and a dephlegmator, wherein the spherical-granule-formation water bath is connected to a midportion of the rectification column via the first heat-exchanger and a second heat-exchanger for passing the solvent-water solution to the regeneration system through the first heat-exchanger and the second heat-exchanger, the third heat exchanger being installed between the top portion of the rectification column and the dephlegmator, wherein the dephlegmator is connected through the first heat-exchanger to a bath irrigation pipe located above the spherical-granule-formation water bath for pouring a portion of a condensate formed in the dephlegmator to the spherical-granule-formation water bath.

16. The apparatus of claim 15, further comprising a fourth heat-exchanger located between the exit and the lower part of the rectification column and intended for heating a high-boiling fraction accumulated at the lower part of the rectification column above the boiling point of water, but lower than the boiling point of the water-miscible solvent.

17. The apparatus of claim 14, wherein the lower part of the rectification column is connected to the first reactor through the second heat exchanger and a second storage tank for feeding the water-miscible solvent to the first reactor where it is reused for preparing the polymer solution.

18. The apparatus of claim 16, wherein the lower part of the rectification column is connected to the first reactor through the second heat exchanger and a second storage tank for feeding the water-miscible solvent to the first reactor where it is reused for preparing the polymer solution.

19. The apparatus of claim 18, wherein a suspension dispersion device is selected from the group consisting of a dripping-type suspension dispersion device, an electrostatic-type suspension dispersion device, a vibration-type suspension dispersion device, a string-cutter type suspension dispersion device, a rotating-disk type suspension dispersion device, and a pneumatic-nozzle type suspension dispersion device.

20. The apparatus of claim 19, wherein a dryer is selected from the group consisting of an air-circulation chamber-type dryer, a rotary-type vacuum dryer, and a fluidized-bed type dryer.
